(19) United States
(12) Patent Application Publication
(10) Pub. No.: US 2021/0304379 A1
(43) Pub. Date: Sep. 30, 2021

(54) System and Methods for an Image Mosaic Representing a Group of Links

(71) Applicant: Platstack, LLC, South Jordan, UT (US)

(72) Inventor: Eslee Buckley Barlow, Bluffdale, UT (US)

(21) Appl. No.: 16/830,238

(22) Filed: Mar. 25, 2020

(51) Int. Cl. G06T 5/50; G06F 40/30

(52) U.S. Cl. CPC G06T 5/50; G06T 2200/24; G06T 2207/20221; G06F 40/30

(57) ABSTRACT

A technology is described for inserting and organizing images in an image mosaic. An example method may include receiving a selection of a link for an electronic media resource included in a grouping of links grouped by a topic description. In response to receiving the selection of the link, an image representing the electronic media resource can be obtained for inclusion in an image mosaic that represents the topic description. A selection of a position in the image mosaic may be received where the selection may be a selection of a portion of the image mosaic to use to contain the image representing the electronic media resource. The image may be inserted in the portion of the image mosaic that corresponds to the position of the image mosaic selected to contain the image.

### BACKGROUND

A network accessible electronic media resource can include text, images, slides, video, music, applications, interactive content, and the like which can be presented using a browser application. A network accessible electronic media resource can be embedded in an electronic page (e.g., a web page or electronic document) which can include a visual element configured to present an overview of the content provided via the electronic media resource. For example, a web banner image, hero image, and/or another type of visual element can be placed in the electronic page to convey a general concept or purpose of the content presented in the electronic page. The visual element can contain text, images, and/or video that relates to the content in the electronic page.

### BRIEF DESCRIPTION OF THE DRAWINGS

FIG. 1 is a block diagram illustrating an example system for including images associated with a topic description in an image mosaic.

FIG. 2 illustrates various example image mosaic templates which can be used to divide an area of an image mosaic into portions and positions to accommodate a defined number of images.

FIGS. 3A-C are diagrams illustrating an example system and method for including images in an image mosaic.

FIG. 4 is a diagram illustrating an example method for using a drag and drop operation to drag a browser application tab into a section sub-container causing an image to be incorporated into an image mosaic.

FIG. 5 is a diagram illustrating an example method for using a drag and drop operation to drag a URI from a section sub-container to an image mosaic causing an image to be incorporated into the image mosaic.

FIG. 6 is a diagram that illustrates an example method for updating an image mosaic to include an image associated with a frequently selected link associated with a topic and reordering the links in a section sub-container based on the frequently selected link.

FIG. 7 is a flow diagram illustrating an example method for including and organizing images in an image mosaic to provide a user with an indication of topics presented in a group container viewed in a topic page in which the image mosaic is displayed.

FIG. 8 is block diagram illustrating an example of a computing device that may be used to execute a method for including images representing a topic into an image mosaic.

### DETAILED DESCRIPTION

A technology is described for incorporating and organizing images in an image mosaic to provide a user with an indication of topics presented in a group container viewed in a topic page, for which the image mosaic is displayed. As one example, the image mosaic can be a visual element for a group container viewed in a topic page (e.g., a web page) containing links (e.g., hyperlinks, URLs, URIs) to electronic media resources (e.g., web pages, electronic documents, images, slides, video, music, applications, interactive content, or other types of media resources that can be provided via a browser application) associated with the topic(s) represented by the images in the image mosaic. In another example, the image mosaic can be presented in a listing of other image mosaics (e.g., in a group of other image mosaics representing a section sub-container of links) and the image mosaic can be selected to open an electronic page showing a list of links related to a topic description of the group container.

The images in the image mosaic can indicate to a user that one or more links related to topics are available via the links included in the group container viewed in a topic page. The user can select (e.g., click, keyboard input, touch and hold input with haptic feedback, etc.) and open the links in the group container to view the electronic media resources associated with an informational topic. In one configuration, the user can select an image in the image mosaic and open the electronic media resource which the link represents.

A user can create a group container viewed in a topic page by selecting links to electronic media resources and adding the links to a section sub-container in the group container viewed in a topic page. In one example, a web application and/or web interface can be provided to allow a user to create the group container and the section sub-containers. The web application may include a web interface configured to allow the user to group links for electronic media resources based on a topic description of a group container with which the electronic media resources are associated.

As part of adding a link for an electronic media resource to a section sub-container of links, an image that represents the electronic media resource can be added into an image mosaic, included as a visual element in the group container, and viewed in a topic page. For example, the web application may be configured to obtain an image used to represent an electronic media resource from a server that hosts the image. The image may be obtained from the server in response to the user action of selecting the link for inclusion in a group container or section sub-container of links for electronic media resources, or the image may be obtained from the server in response to the user selecting the image for inclusion in the image mosaic. The links for the electronic media resources can be grouped in a section sub-container of the group container with a topic description, wherein the electronic media resources contain content that is associated with the topic description.

After obtaining the image, the system can be configured to incorporate the image in the image mosaic. As part of incorporating the image into the image mosaic, a portion of the image mosaic (e.g., whole, half, quarter, etc.) can be selected to contain the image, and a position of the image in the image mosaic (e.g., top, bottom, left, right, etc.) can be selected. As described later in greater detail, a portion of the image mosaic and a position in the image mosaic can be selected to contain the image and can be based on factors that include: a number of images contained within the image mosaic, an ordering of images in the image mosaic, a rank assigned to the image, an ordering in a section sub-container in a group container viewed in a topic page, whether a link was dragged to a portion of the mosaic, and other factors. Where an image is located in the image mosaic may be controlled by a user, may be controlled programmatically, or may be controlled by a combination of both. After selecting the portion of the image mosaic to contain the image and the position of the image in the image mosaic, the image can be inserted into the portion of the image mosaic that corresponds to the position of the image. The images contained in the image mosaic can visually indicate to a user the topics of URIs or URLs that are available via the group container or section sub-containers of links in the group container viewed in a topic page.

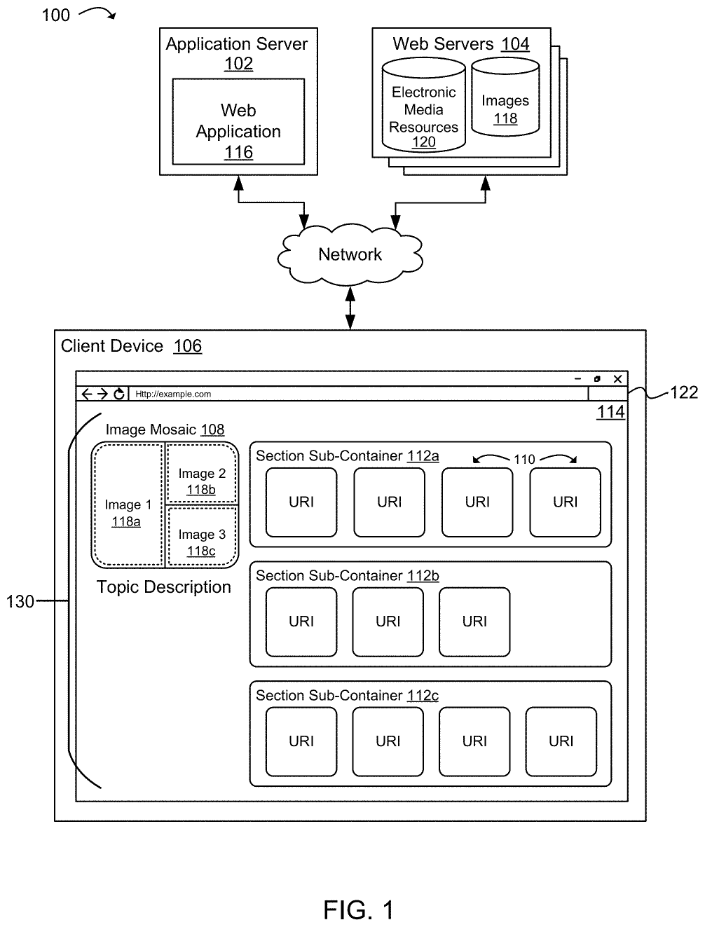

To further describe the present technology, examples are now provided with reference to the figures. FIG. 1 is a diagram illustrating a high level example of system 100 used to receive a selection of a link 110 to an electronic media resource 120 for inclusion in a group container or section sub-container 112a-c. An image 118 representing the electronic media resource 120 may be inserted into an image mosaic 108. In one example, the system 100 may include an application server 102 that hosts a web application 116, a plurality of web servers 104 that host third-party electronic media resources 120, and a client device 106 that hosts a browser application 122 used to execute a web application client (not shown). With the understanding that a web application 116 is a client-server computer program that includes both client code that executes in a browser application 122 and server code that executes on an application server 102, a reference to the web application 116 is a reference to the client-server code that comprises the web application 116. Moreover, it will be understood that the functionality described in relation to the web application 116 may be executed by the client-server code comprising the web application 116.

In one example, the web application 116 hosted on the application server 102 may be configured to allow a user to create a group container 130 viewed in a topic page 114 (e.g., a webpage) containing links 110 (e.g., uniform resource identifiers (URIs) or URLs) to user-curated electronic media resources 120 associated with a main topic of the group container viewed in a topic page 114, and allow the user to publish the group container 114 to other users, allowing the other users to explore the topic and sub-topics via the links 110 contained in the section sub-containers 112a-c included in the group container viewed in a topic page 114. The links 110 in the group container 130 can be organized using section sub-containers 112a-c. A topic of a section sub-container 112a-c may be a sub-topic of the main topic covered by the group container 130. A section sub-container 112a-c can contain links 110 to user-curated electronic media resources having content that corresponds to the sub-topic of the section sub-container 112a-c. In one example, a link 110 included in a section sub-container 112a-c can be represented using a single image that represents an electronic media resource associated with the link 110. Although FIG. 1 shows multiple section sub-containers 112a-c in the group container viewed in a topic page 114, the section sub-containers 112a-c can be arranged in other configurations, such as horizontal rows or clusters of section sub-containers 112a-c. Likewise, although FIG. 1 shows a horizontal listing of links 110 within the section sub-containers 112a-c, the links 110 can be organized in a vertical listing within the section sub-container 112a-c or using another type of organizational scheme.

The group container viewed in a topic page 114 can include an image mosaic 108, which may be a visual component of the group container viewed in a topic page 114 used to represent a topic of the group container viewed in a topic page 114. An image 118a-c included in the image mosaic 108 may represent an electronic media resource 120 having content related to the topic of the topic page 114. For example, an electronic page, such as a web page, may contain the image 118 (e.g., as a banner image, hero image, or an image embedded within the content of the electronic page), and in response to a link 110 for the electronic page being added to a section sub-container 112a-c, the web application 116 may obtain the image 118 from a web server 104 to allow the image 118 to be added to the image mosaic 108. The image 118 can represent the electronic document and the topic associated with the content of the electronic page in the image mosaic 108. In another example, the web application 116 may obtain multiple images 118 from a web server 104, and the web application 116 can select one of the images 118 to add to the image mosaic 108. For example, the web application 116 may be configured to select an image 118 to add to the image mosaic based on various factors, such as image size, resolution, content, the location and/or placement of the image in an electronic document, as well as other factors. In another example, the web application 116 may obtain multiple images 118 from a web server 104 and a user can select which of the images 118 to add to the image mosaic 108.

As described in greater detail later, the web application 116 may provide a graphical user interface that allows a user to add links 110 to the group container and to section sub-containers 112a-c that are logically contained within the group container. In response to adding a link 110 for an electronic media resource 120 to a group container or section sub-container 112a-c, an image 118 used to represent the electronic media resource 120 can be identified, and the image 118 can be inserted into the image mosaic 108. The images 118a-c in the image mosaic 108 can provide viewers of the published group container 130 with an indication or suggestion of the topic and/or sub-topics covered in the group container 130.

An image mosaic 108 provided as a visual component in a group container 130 can be any shape and size. A portion of the image mosaic 108 (e.g., a size of an area within the image mosaic 108) can be selected to contain an image 118a-c, and a position of the image 118a-c within the image mosaic 108 (e.g., top, bottom, left, right, center, etc.) can be selected. The portion of the image mosaic 108 selected for the image 118a-c may be within a shape boundary of the image mosaic 108, where the shape boundary (indicated by the dotted lines within the image mosaic 108) may define an area contained within the image mosaic 108 in which an image 118a-c can be placed. The shape boundary can be any shape, including: a square, polygon, irregular polygon, semi-circle, or any other geometric shape.

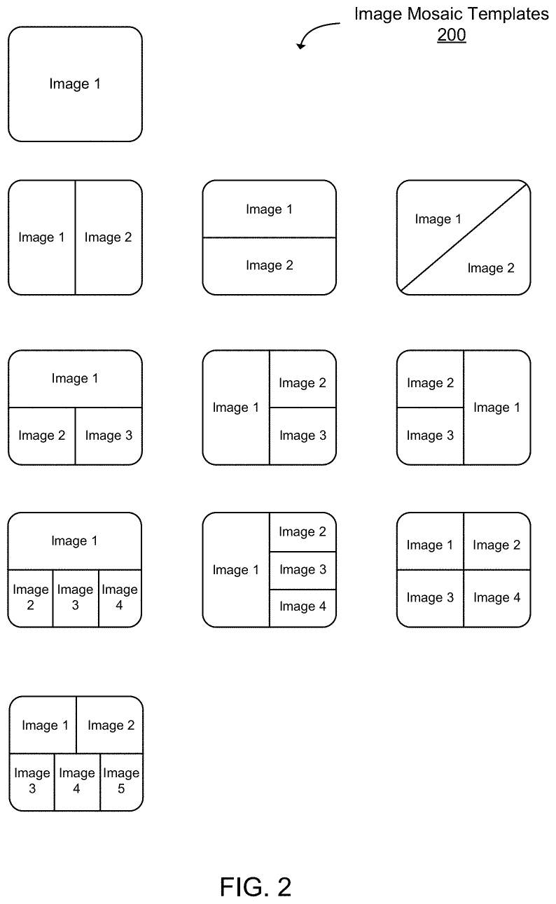

In some examples, a template can be used to provide an image mosaic 108 included in a group container 130. As shown in FIG. 2, an image mosaic template 200 can be used to divide an area of an image mosaic into portions and positions that accommodate a fixed number of images. An image mosaic template 200 selected to provide an image mosaic can be based on a number of images to be included in the image mosaic. Returning to FIG. 1, in another example, the area within an image mosaic 108 can be dynamically portioned to accommodate one or more images 118a-c.

In one example, a user can select a portion (e.g., an area or a percentage) of an image mosaic 108 along with a position in the image mosaic 108 to contain an image 118a-c within a shape boundary. The portion and position in the image mosaic 108 can be selected at the time the user adds a link 110 for an electronic media resource 120 to a section sub-container 112a-c or at a later time after the link 110 has been added to the group container 130. As a non-limiting example, in response to a user adding a link 110 for an electronic media resource 120 to a section sub-container 112a-c, the web application 116 can obtain an image 118 associated with the electronic media resource 120 from a web server 104 and prompt the user to select a portion and position in the image mosaic 106 (e.g., via a user interface select action) for the image 118, and the web application 116 may insert the image 118 in the portion and position of the image mosaic 106 selected by the user.

In another example, selecting a portion and position in an image mosaic 108 for an image 118a-c can be automated. As one example, an automated method can be configured to add images 118a-c to ordered or ranked positions (or slots) in the image mosaic 108. The ordered portions of the image mosaic 108 can be sized relative to the order (or rank) and the number of images 118a-c contained in the image mosaic 108, and images 118a-c can be sequentially added in the ordered portions of the image mosaic template based on an order in which the links 110 were added to the group container 130. In another example, an automated method can be configured to randomly select an open portion of the image mosaic 108 and add an image 118a-c to an image mosaic 108. The automated method may automatically add images 118a-c to the image mosaic 108 in response to a user adding links 110 to a section sub-container 112a-c. For example, in response to a link 110 being added to a section sub-container 112a-c, the web application 116 may identify an open portion or open position in the image mosaic 108 and add an image 118a-c associated with the link 110 to the open portion or open position in the image mosaic 108. This process can be repeated until each open position in the image mosaic 108 is filled with an image 118a-c. Thereafter, a user can replace an image 118a-c in the image mosaic 108 with a new image 118a-c.

In another example, a portion and position in an image mosaic 108 can be determined using factors that include: a number of images 118a-c contained in the image mosaic 108, a rank assigned to the image 118a-c (e.g., based on an ordering in the group container or a use ranking), a hierarchy of section sub-containers 112a-c, and other factors. As one example, a number of images 118a-c contained within an image mosaic 108 may determine a portion of the image mosaic 108 that can be assigned to an image 118a-c. For example, an entire portion of the image mosaic 108 can be selected to contain the image 118a-c when the image 118a-c is the first image to be added to the image mosaic 108. The portion containing the first image can be resized to be half of the image mosaic 108 when a second image is added to the image mosaic 108, such that a first portion of the image mosaic 108 can contain the first image, and a second portion of the image mosaic 108 can contain the second image. The area within the image mosaic 108 can be divided into equal or unequal portions each time an image 118a-c is added to the image mosaic 108, up to a predetermined maximum number of images 118a-c. In the case the image mosaic 108 is full (e.g., the image mosaic 108 contains a maximum number of images 118a-c) a new image may replace another image in the image mosaic 108, or the new image may not be added to the image mosaic 108.

In another example, a rank can be assigned to an image 118a-c used to represent an electronic media resource 120, and the rank can determine a portion of an image mosaic 108 (e.g., an amount of available space) to use to display the image 118a-c in the image mosaic 108. The rank, in one example, may indicate a relevance or importance of the electronic media resource 120 within the context of a section sub-container 112a-c. For example, if the content of an electronic media resource 120 closely aligns with a title or sub-topic of a section sub-container 112a-c, an image associated with the electronic media resource 120 may be assigned a high ranking, whereas content of an electronic media resource 120 that is minimally related to the title or sub-topic of the section sub-container 112a-c may be assigned a lower ranking. The rank, in another example, may be based on image quality, or the ability of the image 118a-c to represent an electronic media resource 120 and/or represent a section sub-container 112a-c. In one example, a user can evaluate an image using any of the factors described above and assign a rank to the image 118a-c. In another example, a computer process (e.g., machine learning) can be configured to evaluate an image 118a-c based on relevance, image quality, or other factors, and assign a rank to the image 118a-c. An image 118a-c assigned a higher rank may be provided a larger portion of an image mosaic 108 as compared to a portion selected for an image 118a-c that has a lower rank.

A rank can also determine a position of an image 118a-c in an image mosaic 108. For example, along with selecting a portion of an image mosaic 108 for the image 108, a position within the image mosaic 108 (e.g., top, bottom, left, right, center, etc.) can be selected for the image 118a-c. An image 108 assigned a higher rank may be placed in a more prominent position (e.g., top or center position) within an image mosaic 108 as compared to other positions in the image mosaic 108. For example, positions within the image mosaic 108 can be ranked, and an image 118a-c assigned a higher ranking may be placed in a higher ranking position in the image mosaic 108. To illustrate the concept of ranking as described above, an image 118a-c that has a higher ranking may be assigned a larger portion of an image mosaic 108 located in a prominent position of the image mosaic 108.

In another example, a portion and a position in an image mosaic 108 selected for an image 118a-c can be based on a hierarchy of section sub-containers 112a-c in a group container 130, where the image 118a-c represents one of the section sub-containers 112a-c in the group container 130. For example, an order of section sub-containers 112a-c (e.g., top to bottom, left to right, etc.) in the group container 130 may constitute a hierarchy of topic descriptions, and an image 118a-c associated with a section sub-container 112a-c at the top of the hierarchy may be assigned a larger portion of the image mosaic 108 and placed in a position within the image mosaic 108 that is more prominent than other positions in the image mosaic 108.

After selecting a portion and position in an image mosaic 108 for an image 118a-c, the image 118a-c can be inserted into the image mosaic 108 at a location that corresponds to the portion and position selected for the image 118a-c. A user can then publish the group container 130 (e.g., post a link to the group container 130 to the Internet or send the link to other users or user groups) to allow viewers of the group container 130 to explore the topic presented by the group container 130 by selecting the links 110 and viewing the content of the electronic media resources 120 associated with the topic.

The application server 102 can comprise computing resources (e.g., a server computer or virtual machine) and a software framework for supporting the web application 116. The application server framework can contain a service layer model used to support the web application 116 by providing a set of application programming interfaces (APIs) used to construct and maintain group containers 130. The web application 116 can comprise a client-server computer program that includes a user interface and client-side logic that executes in a browser application 122 on a client device 106. A user can utilize a client device 106 to access the web application 116 and create/maintain a group container 130. A client device 106 may comprise, for example a processor-based system such as a computing device. A client device 106 may be a device such as, but not limited to, a desktop computer, laptop or notebook computer, tablet computer, handheld computer, workstation, network computer, or other devices with like capability.

The web server 104 may be a server computer which hosts web server software, electronic media resources 120, including webpage component files (e.g. hypertext markup language (HTML) documents, images, cascading style sheets (CSS), and JavaScript files), electronic documents (e.g., documents in a portable document format (PDF), word processer documents, spreadsheets, graphic presentation documents, and the like), images, slides, video, music, applications, interactive content, and other types of media resources that can be provided via a browser application. The web server 104 can also host images 118 which may be used to represent the electronic media resources 120. The web server 104 may be connected to the Internet and may support physical data interchange with other devices connected to the Internet.

API calls, procedure calls, or other network commands may be made in relation to the components of the system 100. API calls may be implemented according to different technologies, including, but not limited to, Representational state transfer (REST) technology or Simple Object Access Protocol (SOAP) technology. REST is an architectural style for distributed hypermedia systems. A RESTful API (which may also be referred to as a RESTful web service) is a web service API implemented using HTTP and REST technology. SOAP is a protocol for exchanging information in the context of Web-based services.

A network used for communications between the components of the system 100 may include any useful computing network, including an intranet, the Internet, a local area network, a wide area network, a wireless data network, or any other such network or combination thereof. Components utilized for such a system may depend at least in part upon the type of network and/or environment selected. Communication over the network may be enabled by wired or wireless connections and combinations thereof. While FIG. 1 illustrates an example of a system that may implement the techniques above, many other similar or different environments are possible. The example environments discussed and illustrated above are merely representative and not limiting.

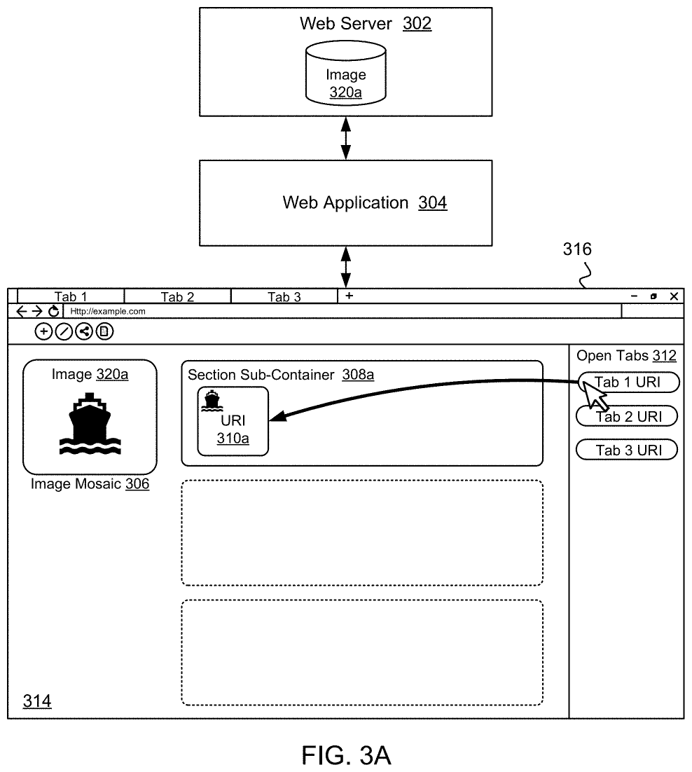

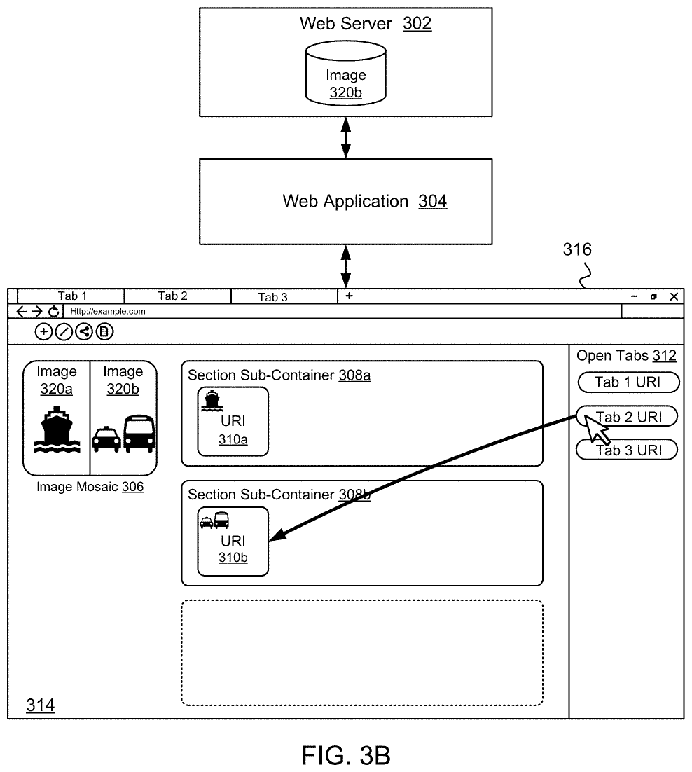

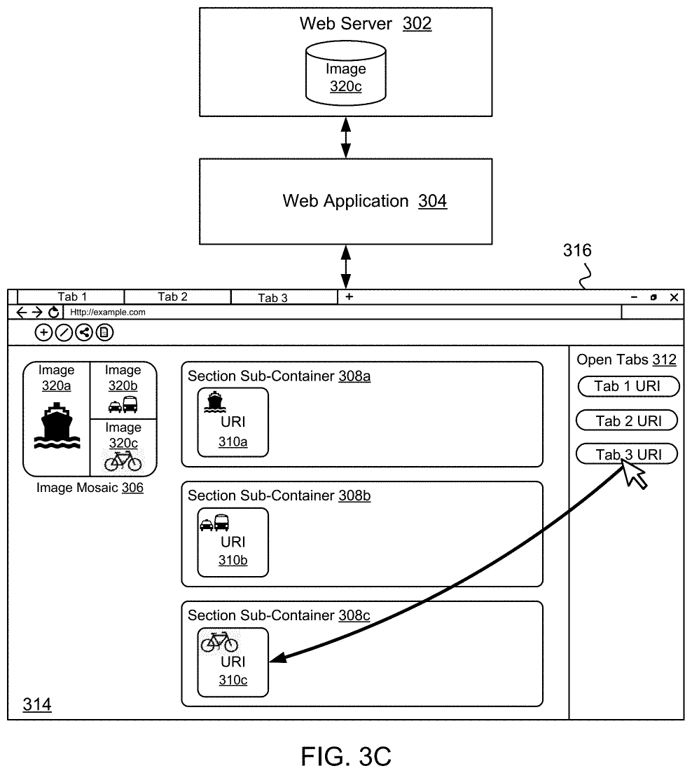

FIGS. 3A-C are diagrams that illustrate an example system and method for inserting images into an image mosaic 306. The system can include a web application 304 that provides a user interface 314 executed in a browser application 316 to allow a user to create a group container that contains links 310a-c to user-selected electronic pages associated with a main topic of the group container. As part of creating the group container, an image that represents a user-curated electronic media resource can be inserted into an image mosaic 306 included as a visual element of the group container.

As shown in FIG. 3A, the user interface 314 can be configured to show a listing of open browser tabs 312 associated with electronic media resources that have been loaded into the browser application 316. A browser tab is a graphical control element of a browser application 316 that allows the browser application 314 to load multiple electronic media resources into computer memory and associate each electronic media resource with a browser tab. The browser tabs can be used as navigational controls to switch between the electronic media resources associated with the browser tabs. The listing of open browser tabs 312 may list electronic media resources that are currently loaded in computer memory and are associated with a browser tab. A user, via the user interface 314, can select an open tab from the listing of open tabs 312 and add a reference 310a to an electronic media resource (e.g., a uniform resource identifier (URI)) associated with the open tab to a section sub-container 308a. For example, the user can use a drag and drop operation, keyboard input, touchscreen input, or a combination of these to select an open tab 312 (e.g., a user interface graphic representing an open tab) and move the open tab 312 to the section sub-container 308a. As will be appreciated, any graphical user interface gesture (including mobile device gestures) which can be used to manipulate virtual objects contained in a graphical user interface can be used to select an open tab and move the open tab to a section sub-container. In a graphical user interface, a drag and drop operation may be performed using a pointing device gesture in which a user selects a virtual object and moves the virtual object to a different location or onto another virtual object. Other types of graphical user interface gestures may use keyboard input, touchscreen input (touch, hold, and move gestures), voice input, or a combination of these to select a virtual object and move the virtual object to a different location or onto another virtual object. In response to adding the reference 310a to the electronic media resource to the section sub-container 308a, the web application 304 may identify an image 320a that represents the electronic media resource and obtain the image 320a from a web server 302 that hosts the image 320a.

In one example, the web application 304 can be configured to identify an image 320a to use to represent an electronic media resource. As one example, the web application 304 can determine whether an electronic media resource includes a meta tag that specifies an image 320a to use to represent the electronic media resource. As a non-limiting example, the web application 304 can parse HTML code of a webpage for metadata that specifies an image 320a to use to represent the webpage (e.g., “<meta property=“og:image” content=“https://example.com/images/image.jpg”>”). The web application 304 can then obtain the image 320a indicated by the meta tag from a web server 302 that host the image 320a.

In cases where an electronic media resource does not include a meta tag that specifies an image for the electronic media resource, the web application 304, in one example, may identify a first image in an ordered arrangement of images in the electronic media resource and select the first image to represent the electronic media resource. For example, the web application 304 can be configured to perform web data extraction or web scraping of an electronic page by obtaining the electronic page from a web server 302 that hosts the electronic page and by parsing the data (e.g., HTML) in the electronic page to identify images contained in the electronic page and to create a list of the images included in the electronic page. In some examples, the web application 304 can be configured to exclude images contained in a header, footer, and/or sidebar from the list of images. The web application 304 can identify the first image in the list and use a reference to the image 320a (e.g., a URI, a URL or resource identifier) extracted from the electronic media resource to obtain the image 320a from a web server 302 that hosts the image 320a. In another example, the web application 304 can be configured to identify the largest image in an electronic media resource and use the image 320a to represent the electronic media resource. For example, the web application 304 can parse the data of an electronic page to identify images contained in the electronic page and create a list of images and image sizes. The web application 304 can identify an image 320a that is larger than other images in the electronic page and obtain the image 320a from a web server 302 that hosts the image 320a as described above. In yet another example, the web application 304 can identify a header image in an electronic page, crop and/or resize the header image as needed, and select the header image to represent the electronic page.

After obtaining an image 320a selected to represent an electronic media resource, the web application 304 can insert the image 320a into an image mosaic 306. As shown in FIG. 3A, in the case that the image 320a is the only image in the image mosaic 306, the image 320a may occupy the entire portion of the image mosaic 306. As additional links to electronic media resources are added to section sub-containers, images representing the electronic media resources may be inserted into the image mosaic 306, up to a maximum number of images that the image mosaic 306 is configured to contain. For example, as shown in FIG. 3B, in response to a user adding a link 310b to an electronic media resource to a section sub-container 308b, an image 320b can be inserted into the image mosaic 306. As part of inserting the image 320b into the image mosaic 306, a portion and position in the image mosaic 306 can be selected to contain the image 320b as described earlier in relation to FIG. 1. For example, as illustrated in FIG. 3B, the area in the image mosaic 306 can be divided into two equal portions to allow a first portion to contain the first image 320a added to the image mosaic 306 and a second portion to contain the new image 320b. FIG. 3C illustrates adding another link 310c for an electronic media resource to a section sub-container 308c may cause the web application 304 to obtain a third image 320c from a web server 302 and add the image 320c to the image mosaic 306, such that the area of the image mosaic 306 can be divided into three portions to allow the third image 320c to be inserted into the image mosaic 306. In the case that an image mosaic template is used (e.g., FIG. 2), adding a new image 320b to the image mosaic 306 may cause the web application 304 to identify an image mosaic template that corresponds to a number of images to be inserted in the image mosaic 306 and insert the images into a portion and position in the image mosaic template.

FIGS. 3A-C illustrate that adding a link 310a-c to a topic description 308a-c causes the web application 304 to insert an image 320a-c to the image mosaic 306. In one example, an image 320a-c representing an electronic media resource from each section sub-container 308a-c, up to an image capacity of the image mosaic 306 (e.g., 3, 4, 5, or 6 images), can be inserted into the image mosaic 306. Each image 320a-c contained in the image mosaic 306 can be used to represent a different sub-topic associated with a section sub-container 308a-c. Also, in one example, the order of links 310a-c for electronic media resources in one section sub-container 308a-b may determine which electronic media resource is represented in the image mosaic 306. As a non-limiting example, an image 320a associated with a link 310a to an electronic media resource that appears first, second, or third in a section sub-container 308a may be selected for inclusion in the image mosaic 306. In another example, multiple images representing electronic media resources from a single section sub-container 308a-b can be included in the image mosaic 306, and electronic media resources from another section sub-container 308a-b may not be represented by an image 320a-c in the image mosaic 306. As will be appreciated, the image mosaic 306 can contain any combination of images 320a-c representing electronic media resources from any combination of section sub-containers 308a-c. As described below, in some examples, a user can determine which electronic media resources are represented by images 320a-c in the image mosaic 306 by selecting a link 310a-c and adding an image 320a-c associated with the link 310a-c to the image mosaic 306. FIG. 3A illustrates a listing of three open browser tabs 312, which can be moved into a section sub-container 308a-c as described earlier. As will be appreciated, the listing of open browser tabs can include any number of open tabs, allowing images representing media resources associated with the open browser tabs to be added to an image mosaic using a drag and drop method or a combination of click input, keyboard input, touchscreen input (e.g., touch, hold, and drag commands), or other types of graphical user interface gestures.

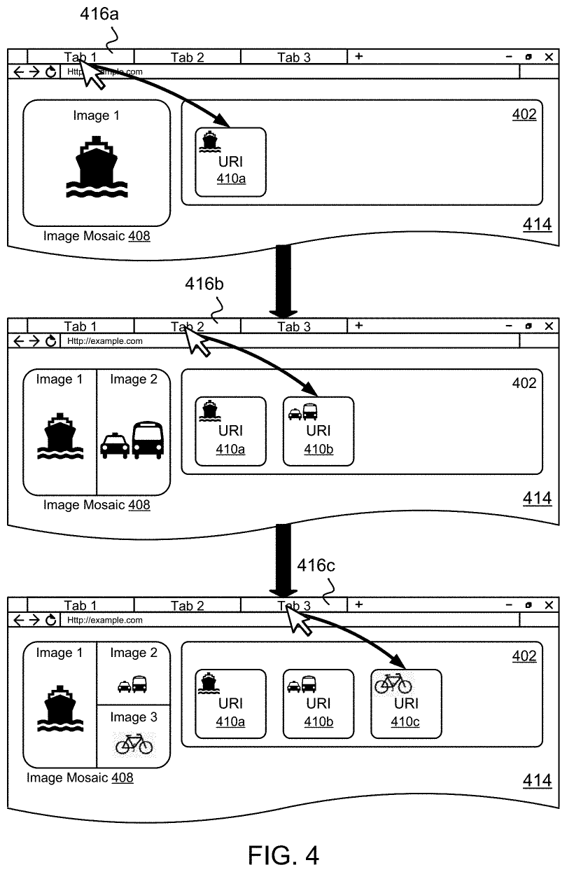

FIG. 4 is a diagram that illustrates an example method for using a drag and drop operation, or another type of graphical user interface gesture, to move a tab of a browser application into a section sub-container 402 causing (i) a link to an electronic media resource to be inserted into the section sub-container 402 and (ii) an image used to represent the electronic media resource to be incorporated into an image mosaic 408. As illustrated, a user, via a graphical user interface 414, can select a tab 416a-c and drag and drop the tab 416a-c in a section sub-container 402. In the context of user interface design, a tabbed document interface (TDI) or tab is a graphical control element that allows multiple media resources to be loaded into a window of a browser application, and the tabs of the browser application can be used as navigational widgets to switch between the media resources.

In response to moving a tab 416a-c associated with a media resource into a section sub-container 402, an virtual object (e.g., an icon, image, etc.) used to represent the media resource may be placed in the section sub-container 402, and the virtual object may include a hyperlink containing a URI 410a-c for the media resource. Also, in response to moving the tab 416a-c associated with a media resource into the section sub-container 402, the web application described earlier may obtain an image associated with the electronic media resource from a web server that host the image and insert the image in the image mosaic 408. The image may be inserted in an available or open portion and position of the image mosaic 408. As described earlier, the area within the image mosaic 408 can be dynamically apportioned to accommodate the image added to the image mosaic 408. Accordingly, when a user moves a tab 416a-c to a section sub-container 402, the area in the image mosaic 408 can be reapportioned into a number of portions having shape boundaries that can accommodate an image used to represent a media resource associated with the tab 416a-c. FIG. 4 illustrates a graphical user interface as having three tabs which can be selected and moved into a section sub-container as described above. As will be appreciated, the graphical user interface can include any number of tabs associated with media resources, allowing images representing the media resources to be added to an image mosaic using the method described above. Also, any graphical user interface gesture (including a combination of click input, keyboard input, touchscreen input, voice input, etc.) that is capable of manipulating a virtual object contained in a graphical user interface can be used to move a tab of a browser application into a section sub-container.

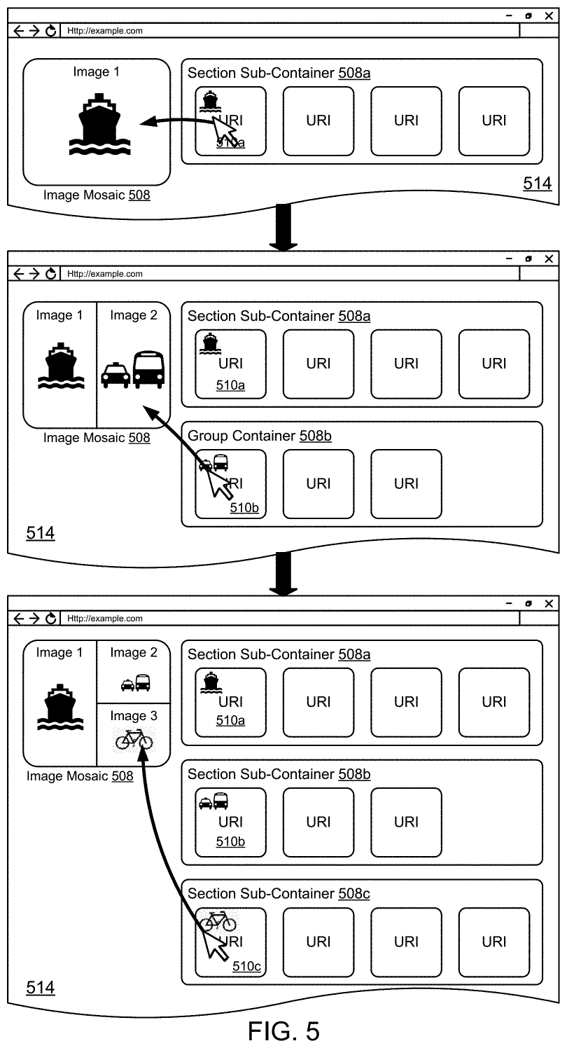

FIG. 5 is a diagram illustrating an example method for using a drag and drop operation, or another type of graphical user interface gesture, to move a URI from a section sub-container 508a-c to an image mosaic 508 causing an image to be incorporated into the image mosaic 508. In the example illustrated, a user, via a graphical user interface 514, can select a link 510a-c for an electronic media resource included in a group container or section sub-container 508a-c and move the link 510a-c into an image mosaic 508. In response to moving the link 510a-c into the image mosaic 508, the web application described earlier may obtain an image associated with the electronic media resource from a web server that host the image and insert the image in the image mosaic 508. The image may be inserted in a portion and position of the image mosaic 508 that corresponds to a location in the image mosaic 508 where the user moved the link 510a-c for the electronic media resource. As described earlier, the area within the image mosaic 508 can be dynamically apportioned to accommodate an image added to the image mosaic 508. Accordingly, when a user moves a link 510a-c to the image mosaic 508, the area in the image mosaic 508 can be reapportioned into a number of portions having shape boundaries that can accommodate the images in the image mosaic 508. In another example, a user can be presented with an image mosaic template that has a number of image positions (or slots) which can be filled with images, as illustrated by the example image mosaic templates shown in FIG. 2. The user can select and move links 510a-c into the image positions, and the web application can obtain images associated with the links 510a-c and insert the images into the image positions selected by the user. As will be appreciated, any graphical user interface gesture (including a combination of click input, keyboard input, touchscreen input, voice input, etc.) that is capable of manipulating virtual objects contained in a graphical user interface can be used to move a URI from a section sub-container to an image mosaic.

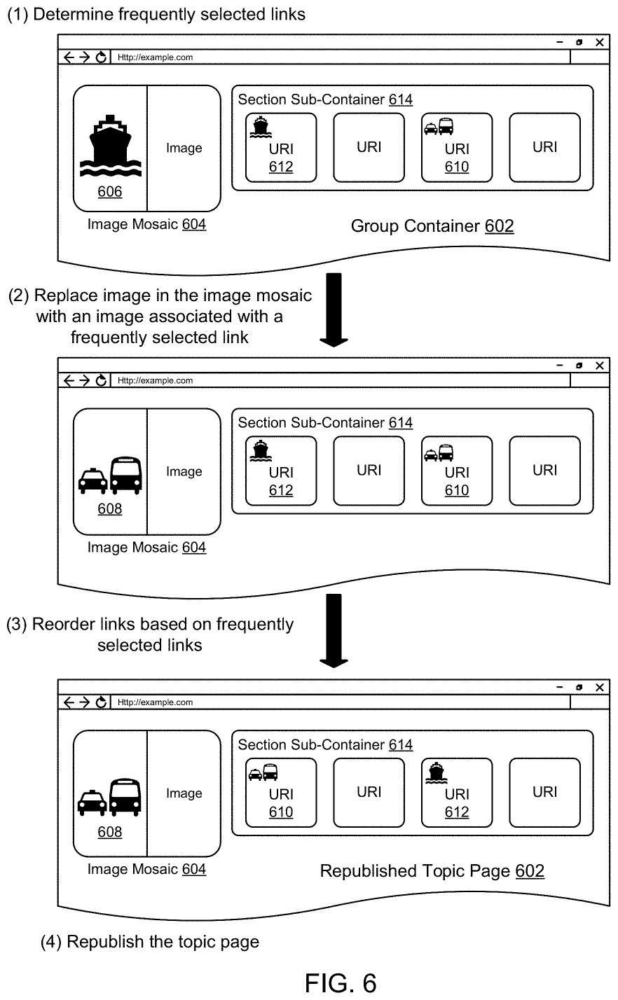

FIG. 6 illustrates an example method for updating an image mosaic 604 to include an image 608 associated with a frequently selected link 610 for an electronic media resource and reordering the links in a group container or section sub-container 614 based on the frequently selected link 610. When a group container 602 is published by a creator, an image mosaic 604 included in the group container 602 can contain images selected by the creator. Also, the organization of links within a section sub-container 614 of the group container 602 can be defined by the creator of the published group container 602.

After publishing the group container 602, user interaction with the links in the group container 602 or section sub-container 614 can be tracked. For example, the web application described earlier can be configured to record instances of a link 610 being selected by a user. Periodically, the web application may determine which links in the section sub-container 614 are the most frequently selected links 610. In one example, the determination of which links are frequently selected can be based on link selections of a user base of the group container 602. In another example, the determination of frequently selected links can be based on an individual user's interaction with links in the group container 602, and the organization of images and links in the group container 602 can be customized to the individual user.

An image 608 associated with a frequently selected link 610 can replace another image 606 in the image mosaic 604. An image 606 chosen to be replaced may be associated with a link that is selected less often than the frequently selected link 610. In one example, each position or slot in the image mosaic 604 can be assigned a rank. A rank can then be determined for each link in a section sub-container 614 based on a selection frequency of a link, and images associated with the most frequently selected links can be inserted into positions in the image mosaic 604 that correspond to the ranks of the images.

Also, the links included in the section sub-container 614 can be rearranged based on the determination of which links are most frequently selected. For example, as illustrated in FIG. 6, the links in a section sub-container 614 can be reordered to move a frequently selected link 610 to a first position in a list of links in the section sub-container 614, and move a less frequently selected link 612 to a position in the list that corresponds to a selection frequency of the link 612. After updating the image mosaic 604 and/or the listing of links in the section sub-container 614, the group container 602 can be refreshed to allow users to interact with the links in the group container 602.

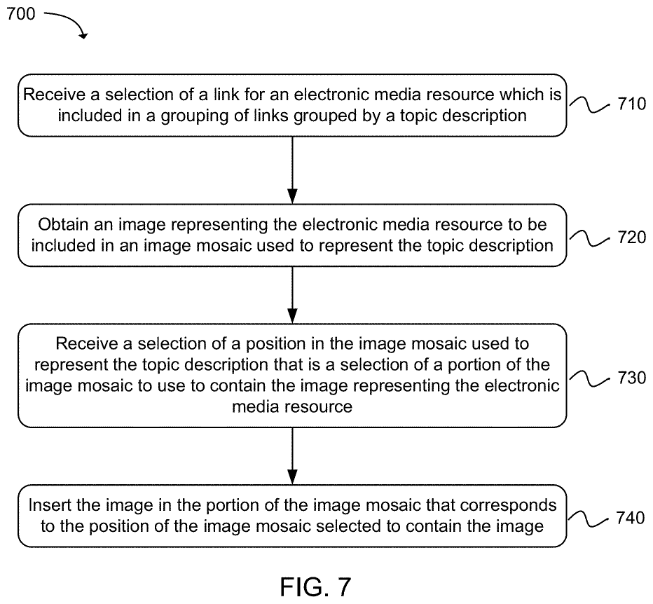

Moving now to FIG. 7, a flow diagram illustrates an example method 700 for inserting and organizing images in an image mosaic to provide a user with an indication of topics presented in an electronic media resource in which the image mosaic is displayed. Starting in block 710, a selection of a link for an electronic media resource may be received, wherein the link for the electronic media resource is included in a grouping of links grouped by a topic description. In one example, a plurality of links grouped by the topic description can be displayed in a group container in a horizontal or vertical listing, and the plurality of links may have images that are related to the topic description.

As in block 720, an image that represents the electronic media resource may be obtained to include in an image mosaic used to represent the topic description. In one example, the image can be identified by searching the electronic media resource for a meta tag that indicates an image to use to represent the electronic media resource, and obtaining the image from a web server that hosts the image. In another example, the image can be identified by generating a list of an ordered arrangement of images contained in the electronic media resource. The first image in the list can be identified and the image can be obtained from a web server that host the image. In yet another example, the image can be identified by identifying the largest image in the electronic media resource as compared to other images in the electronic media resource, and selecting the image to represent the electronic media resource and the topic description in the image mosaic.

As in block 730, a selection of a position in the image mosaic may be received, where the position is a selection of a portion of the image mosaic to use to contain the image representing the electronic media resource. In one example, the selection of the position in the image mosaic may be based on where the link is dragged to in the image mosaic. In one example, the selection of the position in the image mosaic may be based on a rank assigned to the image. The rank, for example, may be based on a relevance of the electronic media resource to the topic description or group container, and the image may be inserted in a position in the image mosaic that corresponds to the rank assigned to the image. In some examples, the selection of the position in the image mosaic may be selection of an entire portion of the image mosaic to contain the image when the link is a first link added to the image mosaic.

As in block 740, the image may be inserted into the portion of the image mosaic that corresponds to the position of the image mosaic selected to contain the image. The image can be displayed in the image mosaic as a representation of the topic description and grouping or sub-grouping of the links. In one example, selection of the image (e.g., clicking on the image, touch and holding with haptic feedback, etc.) in the image mosaic may enable opening of the grouping container for the links through a graphical user interface. For example, a user can select the image in the image mosaic and a grouping of links for which the image represents may be displayed to the user. Alternatively, a single link may be opened when a portion of the image mosaic is selected, and the single link may be the link from which the image in the image mosaic originated.

After inserting the image into the image mosaic, a selection of a second link for an electronic media resource may be received along with a selection of a second position in the image mosaic associated with a portion of the image mosaic. In response, an image associated with the second link may obtained and the image may be inserted in the second position in the image mosaic that corresponds to the portion selected in the image mosaic. In one example, adding a second image to the image mosaic may result in a portion of the image mosaic containing the second image being displayed at an equal size of a first image added to the image mosaic.

In the case that a third image is added to the image mosaic, a portion of the image mosaic used to contain a second image and the third image may be smaller as compared to a portion of the image mosaic used to contain a first image in the image mosaic. A first image, second image, and third image presented in the image mosaic may be within a shape boundary of the image mosaic that can be any of: a circle, square, polygon, irregular polygon, semi-circle, or another geometric shape.

In one example, in addition to adding an image to the image mosaic, the image mosaic can be displayed with a plurality of other images as search results in a key word search interface, wherein the search results are provided based on the topic description or other text associated with the topic description. For example, a key word search interface can be provided with a published group container to allow users to search for a particular topic or sub-topic. Search results provided to a user can include the image added to the image mosaic along with other images associated with the search results.

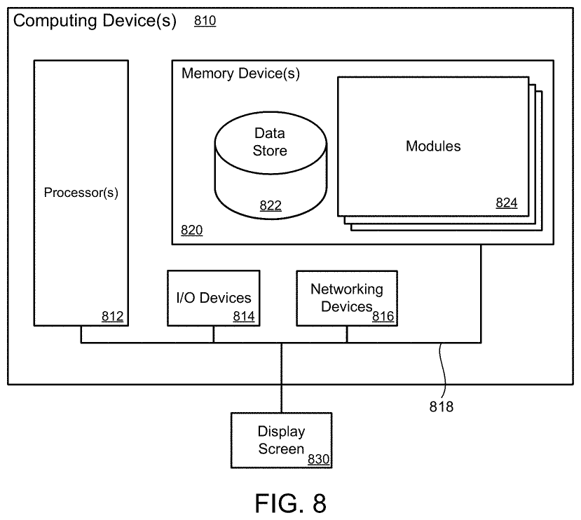

FIG. 8 illustrates a computing device 810 on which modules of this technology may execute. A computing device 810 is illustrated on which a high level example of the technology may be executed. The computing device 810 may include one or more processors 812 that are in communication with memory devices 820. The computing device 810 may include a local communication interface 818 for the components in the computing device. For example, the local communication interface 818 may be a local data bus and/or any related address or control busses as may be desired.

The memory device 820 may contain modules 824 that are executable by the processor(s) 812 and data for the modules 824. In one example, the modules 824 may include web application modules. The modules 824 may execute the functions described earlier. A data store 822 may also be located in the memory device 820 for storing data related to the modules 824 and other applications along with an operating system that is executable by the processor(s) 812.

Other applications may also be stored in the memory device 820 and may be executable by the processor(s) 812. Components or modules discussed in this description that may be implemented in the form of software using high-level programming languages that are compiled, interpreted or executed using a hybrid of the methods.

The computing device 810 may also have access to I/O (input/output) devices 814 that are usable by the computing device 810. One example of an I/O device 814 is a display screen 830 for displaying data. Networking devices 816 and similar communication devices may be included in the computing device. The networking devices 816 may be wired or wireless networking devices that connect to the internet, a LAN, WAN, or other computing network.

The components or modules that are shown as being stored in the memory device 820 may be executed by the processor(s) 812. The term “executable” may mean a program file that is in a form that may be executed by a processor 812. For example, a program in a higher level language may be compiled into machine code in a format that may be loaded into a random access portion of the memory device 820 and executed by the processor 812, or source code may be loaded by another executable program and interpreted to generate instructions in a random access portion of the memory to be executed by a processor. The executable program may be stored in any portion or component of the memory device 820. For example, the memory device 820 may be random access memory (RAM), read only memory (ROM), flash memory, a solid state drive, memory card, a hard drive, optical disk, floppy disk, magnetic tape, or any other memory components.

The processor 812 may represent multiple processors and the memory device 820 may represent multiple memory units that operate in parallel to the processing circuits. This may provide parallel processing channels for the processes and data in the system. The local communication interface 818 may be used as a network to facilitate communication between any of the multiple processors and multiple memories. The local communication interface 818 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A system, comprising:
at least one processor;
a memory device including instructions that, when executed by the at least one processor, cause the system to:
receive a selection of a link for an electronic media resource which is included in a grouping of links grouped by a topic description;
obtain an image representing the electronic media resource to be included in an image mosaic used to represent the topic description;
receive a selection of a position in the image mosaic used to represent the topic description that is a selection of a portion of the image mosaic to use to contain the image representing the electronic media resource; and
insert the image in the portion of the image mosaic that corresponds to the position of the image mosaic selected to contain the image.

2. The system as in claim 1, further comprising instructions that cause the system to:
display the image as a representation of the topic description and sub-grouping of links in the image mosaic to enable opening of at least one of the sub-grouping of links through a graphical user interface.

3. The system as in claim 1, further comprising instructions that cause the system to:
display the image with a plurality of other images as search results in a key word search interface, wherein the search results are provided based on the topic description or other text associated with the topic description.

4. The system as in claim 1, further comprising instructions that cause the system to:
receive a selection of a second link for an electronic media resource;
receive a selection of a second position in the image mosaic used to represent the topic description by receiving a selection of a portion of the image mosaic; and
insert the image in the second position in the image mosaic that corresponds to the portion selected in the image mosaic.

5. The system as in claim 1, wherein the selection of the position in the image mosaic is based on where the link is dragged in the image mosaic.

6. The system as in claim 1, further comprising instructions that cause the system to:
display a plurality of links in a horizontal or vertical listing, wherein the plurality of links have images that are related to the topic description.

7. The system as in claim 1, further comprising instructions that cause the system to:
receive a selection of an entire portion of the image mosaic to contain the image when the link is a first link added to the image mosaic.

8. The system as in claim 1, further comprising instructions that cause the system to:
add a second image to the image mosaic, wherein a portion of the image mosaic used to contain the second image is displayed at an equal size of a first image added to the image mosaic.

9. The system as in claim 1, further comprising instructions that cause the system to:
add a third image to the image mosaic, wherein a portion of the image mosaic used to contain a second image and the third image is smaller as compared to a portion of the image mosaic used to contain a first image added to the image mosaic.

10. The system as in claim 1, further comprising instructions that cause the system to:
present a first image, a second image, and a third image within a shape boundary of the image mosaic that is a rectangle with rounded corners.

11. The system as in claim 1, further comprising instructions that cause the system to:
present a first image, a second image, and a third image within a shape boundary that is at least one of: a square, circle, rectangle, polygon, irregular polygon, semi-circle, or a geometric shape.

12. The system as in claim 1, further comprising instructions that cause the system to:
assign a rank to the image based on a relevance of the electronic media resource to the topic description;
identify a position in the image mosaic that corresponds to the rank assigned to the image; and
insert the image in the position in the image mosaic that corresponds to the rank assigned to the image.

13. A computer implemented method, comprising:
receiving a link for an electronic media resource for inclusion in a grouping of links for electronic media resources associated with a topic description;
obtaining a list of images included in the electronic media resource from a web server that hosts the electronic media resource;
identifying an image in the list of images to represent the electronic media resource;
obtaining the image from a web server that hosts the image;
assigning a rank to the image based on a relevance of the electronic media resource to the topic description;
selecting a portion of an image mosaic to use to contain the image representing the electronic media resource;
identifying a position in the image mosaic that corresponds to the rank assigned to the image; and
inserting the image in the position in the image mosaic that corresponds to the rank assigned to the image using the portion of the image mosaic selected to contain the image.

14. The method in claim 13, wherein identifying the image to represent the electronic media resource further comprises identifying a meta tag which indicates the image used to represent the electronic media resource.

15. The method in claim 13, wherein identifying the image to represent the electronic media resource further comprises identifying a first image in an ordered arrangement of images in the electronic media resource.

16. The method in claim 13, wherein identifying the image to represent the electronic media resource further comprises identifying a largest image as compared to other images in the electronic media resource.

17. A computer implemented method, comprising:
identifying a plurality of links in a group container, wherein the plurality of links are included in a grouping of links for electronic media resources associated with a topic description;
determining rankings of the plurality of links based on page view histories of the links displayed in the group container for the topic description;
obtaining images for at least three links included in the plurality of links, based on the rankings of the at least three links;
identifying a position in an image mosaic for each of the images that corresponds to the rankings of the at least three links; and
inserting each of the images in the position in the image mosaic that corresponds to the rankings of the at least three links, wherein the images are automatically inserted into the image mosaic.

18. The computer implemented method as in claim 17, further comprising obtaining an image for a link from a web server that hosts an electronic media resource.

19. The computer implemented method as in claim 17, further comprising:
tracking a user-selection of the links for the electronic media resources;
identifying an image associated with a frequently selected link; and
inserting the image in the image mosaic to replace another image associated with a less frequently selected link that is selected less frequently as compared to the frequently selected link.

20. The computer implemented method as in claim 19, further comprising reordering the links in the grouping of links or a section sub-container based on a frequency that the links are selected, wherein the frequently selected link is placed in a first position of the grouping of links.
